(19) United States
(12) Patent Application Publication
(10) Pub. No.: US 2016/0223068 A1
(43) Pub. Date: Aug. 4, 2016

(54) Modularized Idler Shaft

(71) Applicant: Caterpillar Inc., Peoria, IL (US)

(72) Inventor: Thomas Hylton, Delphi, IN (US)

(73) Assignee: Caterpillar Inc., Peoria, IL (US)

(21) Appl. No.: 14/612,082

(22) Filed: Feb. 2, 2015

(51) Int. Cl. F16H 57/00

(52) U.S. Cl. CPC F16H 57/0018

(57) ABSTRACT

An example idler shaft assembly in accordance with the present disclosure may include a ring, a shaft, a dowel, and a fastener. The ring and the shaft may each have openings that are coaxial with respect to each other. The fastener may be inserted into the openings in the ring and shaft to coupled them together. The dowel may be coupled into a portion of the shaft's opening via interference fit. The ring and the shaft may be non-concentric with respect to each other.

### TECHNICAL FIELD

This disclosure relates generally to an idler shaft assembly for machines, and, more particularly, to a idler shaft assembly having separately manufactured components coupled together to form the idler shaft assembly.

### BACKGROUND

Machine engines generally include internal combustion engines, which may be that of a four-stroke, compression ignition engine and may include an engine block defining a plurality of combustion chambers or cylinders. Engines have various types (e.g., internal combustion, gas, diesel, gaseous fuel, natural gas, propane, etc.), various sizes, various number of cylinders, various types of combustion chamber (e.g., cylindrical, rotary spark ignition, compression ignition, 4-stroke and 2-stroke, etc.), and have various configurations (e.g., “V,” in-line, radial, etc.).

The complexity of engines requires complex manufacturing processes to manufacture conventional engine components. For example, conventional idler shaft assemblies are manufactured using costly materials (e.g., high quality steel) and complex processes. Conventional idler shaft assemblies are unitary components that provide a rigid non-concentric idler shaft that maintains center distances needed for proper meshing of gears while they transmit axial torque at a uniform constant velocity. Cheaper materials and easier manufacturing processes, while maintaining the effectiveness and reliability of the idler shaft assemblies, are desirable.

In some instances, such as in U.S. Patent App. Pub. No. 20090084207, titled “Split shaft for high power diesel engine,” an idler shaft assembly having a split shaft is purported to be an improved design. However, this solution and other conventional solutions require multiple gears and/or hubs within the idler shaft assemblies, thus adding complexity and potential manufacturing issues, which add to manufacturing costs. Accordingly, there is a need for improved mechanisms to reduce complexity and/or costs associated with idler shaft assemblies.

### SUMMARY

In one aspect, the present disclosure discloses an idler shaft assembly that includes a ring, a shaft, and a dowel. The ring may have a ring opening defining a first axis. The shaft may be removably coupled to the ring, and the shaft may have a shaft opening defining a second axis. The dowel may be removably coupled to the shaft, and the dowel may have a third axis. The first axis, the second axis, and the third axis may be coaxial.

In another aspect, the present disclosure discloses a method of producing an idler shaft assembly that includes coupling a ring to a shaft, and coupling a dowel to the shaft using an interference fit.

In yet another aspect, the present disclosure discloses an idler shaft assembly that includes a cylindrical ring, a cylindrical shaft, a fastener, and a cylindrical dowel. The cylindrical ring may have a ring bore extending through it. The cylindrical shaft may have a shaft bore extending through it. The fastener may couple the cylindrical ring to the the cylindrical shaft through the ring bore and the shaft bore. The cylindrical dowel may be inserted into at least a portion of the shaft bore.

### BRIEF DESCRIPTION OF THE DRAWINGS

FIG. 1 is a perspective view of an engine gear train having an example idler shaft assembly in accordance with at least one embodiment of the present disclosure.

FIG. 2 is an exploded, perspective view of an example idler shaft assembly in accordance with at least one embodiment of the present disclosure.

FIG. 3 is a sectional view of an example idler shaft assembly in accordance with at least one embodiment of the present disclosure.

### DETAILED DESCRIPTION

It should be noted that the methods and systems described herein may be adapted to a large variety of machines. The machine may be vehicle that performs some type of operation associated with an industry such as mining, construction, farming, transportation, or any other industry known in the art. For example, the machine may be an earth-moving machine, such as an excavator, dozer, wheel loader, dump truck, backhoe, motor grader, material handler, and the like. In some examples, the machine may be a marine vehicle, a locomotive, or may be a generator.

Further, it should be noted that the Figures are illustrative only and they are not drawn to scale.

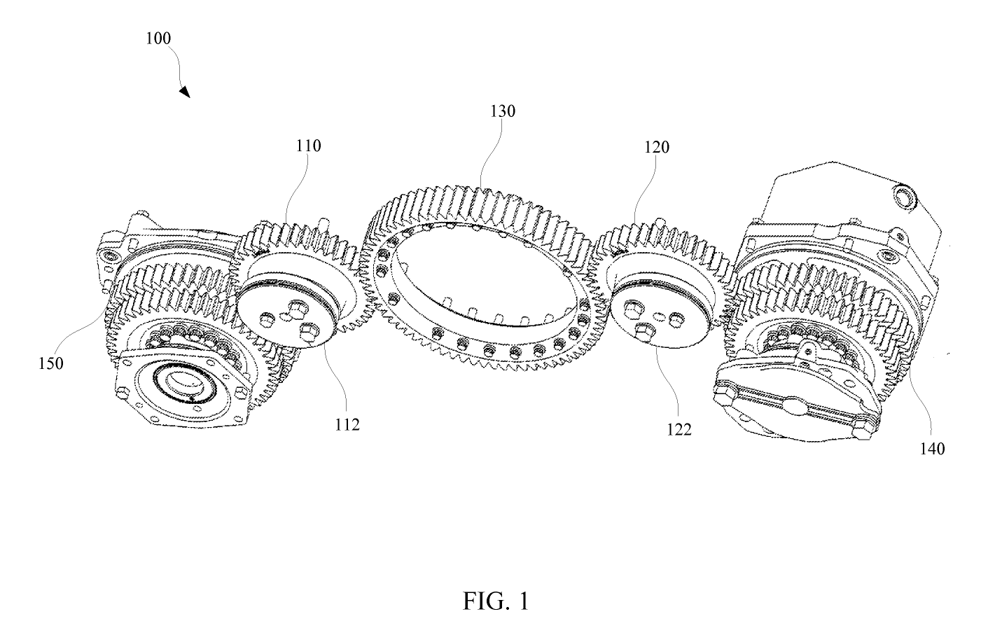

FIG. 1 is a perspective view of an engine gear train 100 having an example idler shaft assembly 112, 122 in accordance with at least one embodiment of the present disclosure.

In the context of an internal combustion engine, it is common to utilize a series of gears or a gear train 100 to power certain engine components, and to provide for a desired relative timing between the gears. The gear train 100 may include several gears, such as a driving gear, idler gears, and driven gears, used for transferring torque and speed. The gear train 100 may be used in engine applications and, according to a particular engine application, may include a crank gear 130 drivingly coupled with a cam gear 140, 150 through idler gears 110, 120. One or more idler gears 110, 120 may be operably disposed between the crank and cam gears to maintain a relative timing between the two such that certain engine functions may operate efficiently. Idler shaft assemblies 112, 122 may be coupled to the idler gears 110, 120. Idler shaft assemblies 112, 122 have an outer diameter that may be interference fit within an inner diameter of each idler gear 110, 120. Among other functions, idler shaft assemblies 112, 122, may control an offset to allow gears to freely rotate about a concentric or non-concentric shaft while transmitting torque from one gear to another.

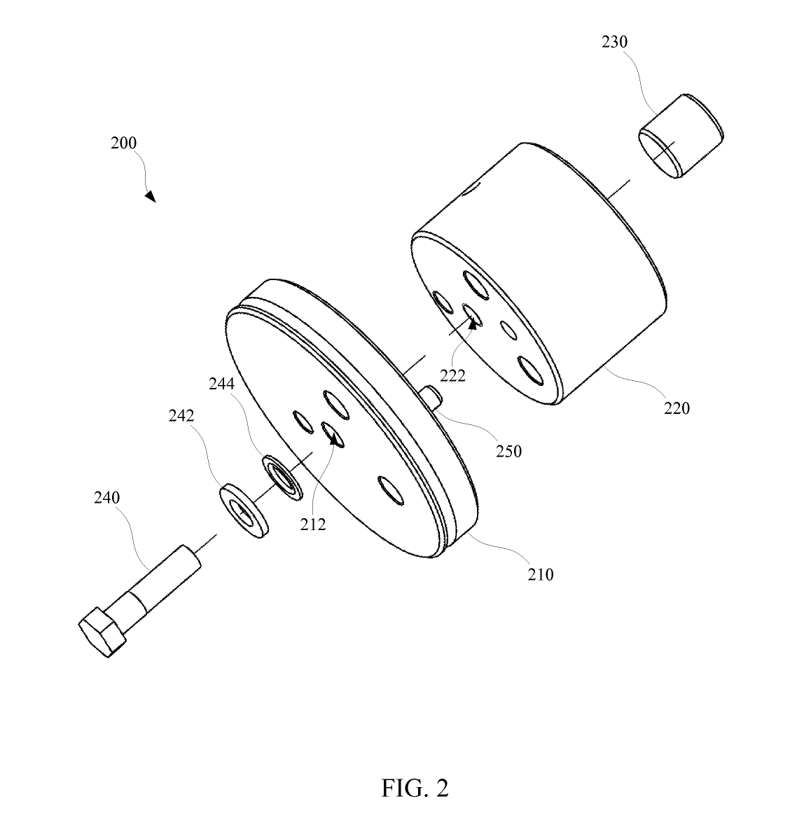

FIG. 2 is an exploded, perspective view of an example idler shaft assembly 200 in accordance with at least one embodiment of the present disclosure. Idler shaft assembly 200 may include a ring 210, a shaft 220, and a dowel 230. In some examples, the ring 210, shaft 220, and dowel 230 may be separate, independent components that may be coupled together to form the idler shaft assembly 200. In this manner, each of the ring 210, the shaft 220, and the dowel 230 may be manufactured from different processes and/or or sourced from different vendors and then combined to form the idler shaft assembly 200. In some examples, the ring 210, the shaft 220, and/or the dowel 230 may be manufactured from different materials.

The ring 210 may be cylindrical in shape, having two opposing faces having a diameter. The ring 210 may have an opening (i.e., ring opening 212 or ring bore) bored therethrough. This ring opening 212 may extend all the way through the ring 210 from one face of the ring 210 to the opposing face of the ring 210. The ring opening 212 may define an axis.

In some examples, the ring 210 may be pre-hardened, non-heat-treated material, such as carbon steel, powdered metal, or other similar material.

Similarly, the shaft 220 may be cylindrical in shape, having two opposing faces having a diameter. The shaft's 220 diameter may be less than the ring's 210 diameter. The shaft 220 may have an opening (i.e., shaft opening 222 or shaft bore) bored therethrough. This shaft opening 222 may extend all the way through the shaft 220 from one face of the shaft 220 to the opposing face of the shaft 220. The shaft opening 222 may define an axis. In some examples, the shaft opening 222 may have varying diameters throughout the shaft opening 222.

In some examples, the shaft 220 may be heat-treated material such as carbon steel, or other similar materials that may be heat-treated up to a hardening applicable for a given application.

In some examples, the ring 210 and shaft 220 may be coupled together with a fastener 240 (e.g., bolt, screw, press fit dowel) that may be inserted through the ring 210 and into the shaft 220. Some example fasteners 240 may utilize washer(s) 242, 244 for assisting with distributing any load placed on the fastener 240 and prohibiting oil from leaking out. In the example of FIG. 2, a bolt-type fastener 240 is inserted into washers 242, 244 prior to the fastener 240 being inserted into the ring 210 and shaft 220.

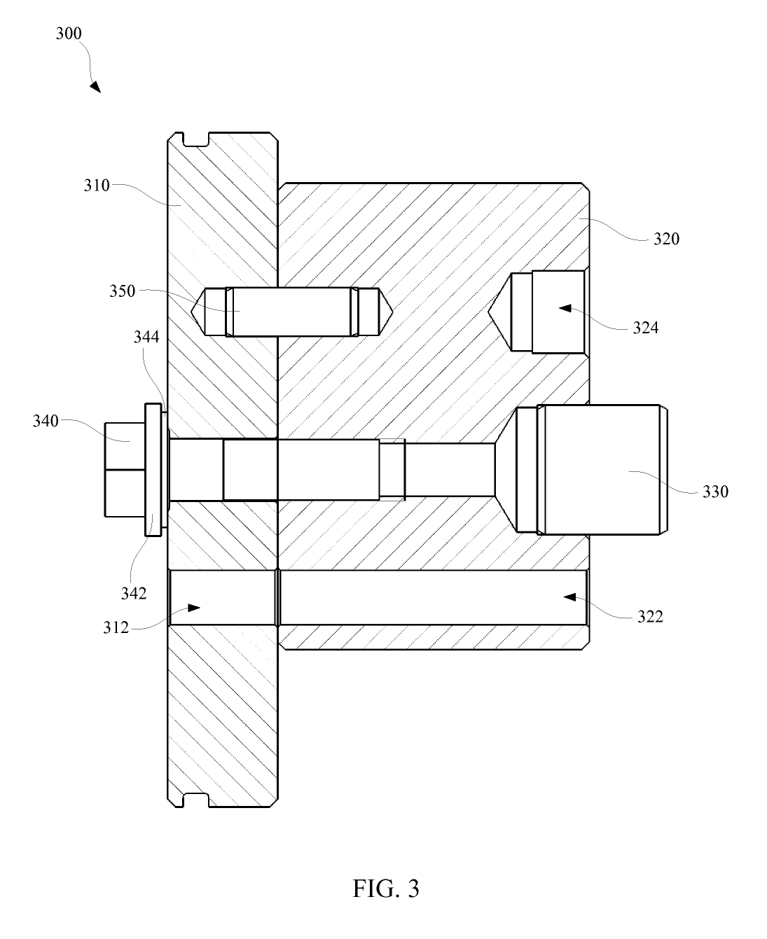

The ring 210 may be coupled to the shaft 220 such that relative movement between the ring 210 and the shaft 220 is restricted or prohibited. For example, a dowel pin 250 may engage both the ring 210 and the shaft 220. For example, the dowel pin 250 may be removably coupled to the ring 210 and also removably coupled to the shaft 220. When the ring 210 and the shaft 220 are engaged (as depicted in FIG. 3), the dowel pin 250 may engage both the ring 210 and the shaft 220 via recesses in each of the ring 210 and the shaft 220. The dowel pin 250 may have an interference (or press) fit with the ring 210 and the shaft 220. The dowel pin 250 may control the orientation of the ring 210 relative to the shaft 220.

The dowel 230 may be cylindrical in shape, having two opposing faces. The dowel 230 may define an axis. The dowel 230 may be coupled to the face of the shaft 220 that is opposite the face of the shaft 220 that is engaging the ring 210. In some examples, the dowel 230 may be partially inserted into the shaft opening 222 via interference (or press) fit. In this manner, the dowel 230 may effectively act as one assembly with the shaft 220. The dowel 230 may assist in maintaining the orientation of the shaft 220 relative to other gears in the gear train.

In some examples, the dowel 230 may be pre-hardened, non-heat-treated material such as carbon steel, or other similar materials that may be heat-treated up to a hardening applicable for a given application.

When assembled, the ring opening 212, the shaft opening 222, and the dowel 230 may be aligned such that each of their respective axes are coaxial. However, the ring 210, the shaft 220, and/or the dowel 230 may not be concentric. For example, the shaft opening 222 in the shaft 220 may “off center” and the ring opening 212 in the ring 210 may be centered, thus leading the ring 210 and shaft 220 being non-concentric.

FIG. 3 is a sectional view of an example idler shaft assembly 300 in accordance with at least one embodiment of the present disclosure. The idler shaft assembly 300 may include a ring 310, a shaft 320, and a dowel 330. The ring 310 and the shaft 320 may be coupled via a bolt 340 having washers 342, 344. The bolt 340 extends through an opening in the ring 310 and into an opening in the shaft 320. In some examples, the bolt 340 may include threads such that the bolt may extend through the opening in the ring 310 and be received by a threaded portion inside the opening in the shaft 320.

The ring 310 and the shaft 320 are further coupled by the dowel pin 350 interfacing with a recess in the ring 310 and a recess in the shaft 320. The dowel pin 350 further restricts movement of the ring 310 relative to the shaft 320. The bolt 340 and the dowel pin 350 may cause the ring 310 and the shaft 320 to effectively act as a single component because the relative movement therebetween is restricted.

The dowel 330 is interference (or press) fit into the opening of the shaft 320. In some examples, the opening of the shaft 320 may have a larger diameter where it interfaces with the dowel 330 than the diameter where it receives the bolt 340.

### INDUSTRIAL APPLICABILITY

The industrial applicability of example idler shaft assemblies described herein will be readily appreciated from the foregoing discussion.

The idler shaft assemblies described herein reduce the complexities of manufacturing idler shaft assemblies that currently exist. Components of idler shaft assemblies may now be manufactured separately and later assembled. In this manner, each component may be manufactured by different plants or vendors and then assembled at the factory. The distinct components of the idler shaft assemblies may also allow easier replacement of defective components at the factory prior to shipping the assembled idler shaft assembly. For example, manufacturing errors in conventional idler shaft assemblies would cause the entire assembly to be defective. The present disclosure allows for defective components to be replaced rather than the entire assembly.

The present disclosure's idler shaft assemblies also provide for cheaper parts costs. For example, instead of using high quality steel for an entire convention idler shaft assembly, the present disclosure teaches that components of idler shaft assemblies may be made of different materials. Certain components such as the shaft may be manufactured using high quality materials, while other components such as the ring and dowel may be manufactured using lower quality (and presumably lower priced) materials. In some examples, cost savings have been estimated between about 15-30% less than conventional idler shaft assemblies.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

All methods described herein may be performed in any suitable order unless otherwise indicated herein or otherwise clearly contradicted by context.

We claim:

1. An idler shaft assembly, comprising:
a ring having a ring opening defining a first axis;
a shaft removably coupled to the ring, the shaft having a shaft opening defining a second axis; and
a dowel removably coupled to the shaft, the dowel having a third axis;
wherein the first axis, the second axis, and the third axis are coaxial.

2. The idler shaft assembly of claim 1, further comprising:
a bolt coupling the ring and the shaft, the bolt engaged within the ring opening and at least partially within the shaft opening.

3. The idler shaft assembly of claim 1, further comprising:
a dowel pin coupling the ring and the shaft, the fastener restricting relative movement between the ring and the shaft.

4. The idler shaft assembly of claim 3, wherein the dowel pin is coupled to the ring and the shaft via an interference fit.

5. The idler shaft assembly of claim 1, wherein the dowel is coupled to the shaft via an interference fit.

6. The idler shaft assembly of claim 1,
wherein the ring and the shaft are each cylindrical, and
wherein the ring and the shaft are non-concentric.

7. The idler shaft assembly of claim 6, wherein a diameter of the ring is greater than a diameter of the shaft.

8. The idler shaft assembly of claim 7, wherein the diameter of the ring is in a range of about 130 mm and a diameter of the shaft is in a range of about 90-106 mm.

9. The idler shaft assembly of claim 1,
wherein the shaft and the shaft opening are each cylindrical; and
wherein the shaft opening and the shaft are non-concentric.

10. A method of producing an idler shaft assembly, the method comprising:
coupling a ring to a shaft; and
coupling a dowel to the shaft using an interference fit.

11. The method of claim 10,
wherein the ring includes a ring opening extending from a front face of the ring to a rear face of the ring;
wherein the shaft includes a shaft opening extending from a front face of the shaft to a rear face of the shaft; and
wherein coupling the ring to the shaft comprises inserting a bolt through the ring opening and at least partially into the shaft opening.

12. The method of claim 10,
wherein the ring includes a ring opening extending from a front face of the ring to a rear face of the ring;
wherein the shaft includes a shaft opening extending from a front face of the shaft to a rear face of the shaft; and
wherein coupling the ring to the shaft comprises inserting a dowel pin into a recess in the rear face of the ring and into a recess in the front face of the shaft.

13. The method of claim 10,
wherein the shaft includes a shaft opening extending from a front face of the shaft to a rear face of the shaft; and
wherein coupling the dowel to the shaft using the interference fit comprises inserting the dowel into a recess in the rear face of the shaft.

14. The method of claim 10, further comprising:
prior to coupling the ring to the shaft, heat-treating the shaft.

15. An idler shaft assembly, comprising:
a cylindrical ring having a ring bore extending therethrough;
a cylindrical shaft having a shaft bore extending therethrough;
a fastener coupling the cylindrical ring and the cylindrical shaft via the ring bore and the shaft bore; and
a cylindrical dowel inserted into at least a portion of the shaft bore.

16. The idler shaft assembly of claim 15, wherein a diameter of the cylindrical ring is greater than a diameter of the cylindrical shaft.

17. The idler shaft assembly of claim 15, wherein the cylindrical ring and the cylindrical dowel are concentric.

18. The idler shaft assembly of claim 15, wherein the shaft bore is not concentric with the cylindrical shaft.

19. The idler shaft assembly of claim 15, wherein the ring bore is concentric with the cylindrical ring.

20. The idler shaft assembly of claim 15, wherein the shaft is comprised of a heat-treated metal.
